(19) United States
(12) Patent Application Publication
(10) Pub. No.: US 2007/0027993 A1
(43) Pub. Date: Feb. 1, 2007

(54) SERVER, CLIENT, METHOD FOR OPERATING A SERVER AND METHOD FOR OPERATING A CLIENT

(75) Inventors: NORBERT SCHWAGMANN, Braunschweig (DE); ANDREAS SCHMIDT, Braunschweig (DE); HOLGER SCHMIDT, Braunschweig (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Munich (DE)

(21) Appl. No.: 11/456,822

(22) Filed: Jul. 11, 2006

(30) Foreign Application Priority Data
Jul. 11, 2005 (DE) 102005032302.2-31

(51) Int. Cl. G06F 15/16

(52) U.S. Cl. 709/227

(57) ABSTRACT

A server of a communication system which decides, in a case of a conflict between a request that no invitation to participate in a communications session should be forwarded to a first client and a request that a second client invite the first client to participate in a communication session, whether an invitation to participate in a communication session is forwarded to the first client.

### CROSS-REFERENCE TO RELATED APPLICATION

This application claims priority to German Patent Application Serial No. 10 2005 032 302.2-31, which was filed on Jul. 11, 2005, and is incorporated herein by reference in its entirety.

### TECHNICAL FIELD

The invention relates to a server, a client, a method for operating a server and a method for operating a client.

It is desirable to expand the functionality of the Push-to-talk-over-Cellular communication service with regard to blocking unwanted invitations to communication sessions and requesting a callback.

### BRIEF DESCRIPTION OF THE INVENTION

A server having a decision circuit configured to decide, based on conflict information provided to the server, which specifies whether there is a conflict between first and second request messages sent by a first client, whether an invitation to participate in a communication session sent by a second client and directed to the first client, is forwarded to the first client. The first request message specifies that no invitations from the second client to the first client to participate in a communication session should be forwarded to the first client, and the second request message specifies that the second client should invite the first client to a communication session.

### BRIEF DESCRIPTION OF THE FIGURES

Exemplary embodiments of the invention are shown in the figures and are explained in greater detail in the text which follows.

FIG. 1 shows a message flow diagram according to the prior art.

FIG. 2 shows a message flow diagram according to the prior art.

FIG. 3 shows a communication system according to an exemplary embodiment of the invention.

FIG. 4 shows a diagrammatic view of a communication terminal according to an exemplary embodiment of the invention.

FIG. 5 shows a flow diagram according to an exemplary embodiment of the invention.

FIG. 6 shows a message flow diagram according to an exemplary embodiment of the invention.

FIG. 7 shows a flow diagram according to an exemplary embodiment of the invention.

FIG. 8 shows a message flow diagram according to an exemplary embodiment of the invention.

FIG. 9 shows a flow diagram according to an exemplary embodiment of the invention.

FIG. 10 shows a message flow diagram according to an exemplary embodiment of the invention.

### DETAILED DESCRIPTION

The Push-to-talk-over-Cellular (PoC) communication service enables a user of a mobile radio terminal to transmit voice data to one or more receivers at the same time.

For this purpose, the mobile radio terminal is typically provided with a special PoC key, after the operation of which the user can begin with entering voice data.

The voice data are usually distributed, that is to say transmitted to the desired receiver or receivers by means of a mobile radio communication network even while they are being entered. This process is called “streaming”.

Transmission takes place in half-duplex mode, that is to say that only the sender, that is to say the user who enters and sends out the voice data, can transmit voice data to the receivers during the entering and during the transmission, but the receivers cannot send voice data to the sender at the same time. In particular, the sender cannot be interrupted by the receivers.

To illustrate, a communication by means of PoC corresponds to conventional CB radio from the point of view of the user, but with the extension that the sender can transmit voice data all over the world to receivers which can be reached by means of suitable switching technology by means of at least a mobile radio communication network.

Users of PoC who are involved actively, that is to say as senders, or passively, that is to say as receivers, in a PoC communication, that is to say a communication session by means of PoC, are called PoC participants in the PoC communication in the text which follows.

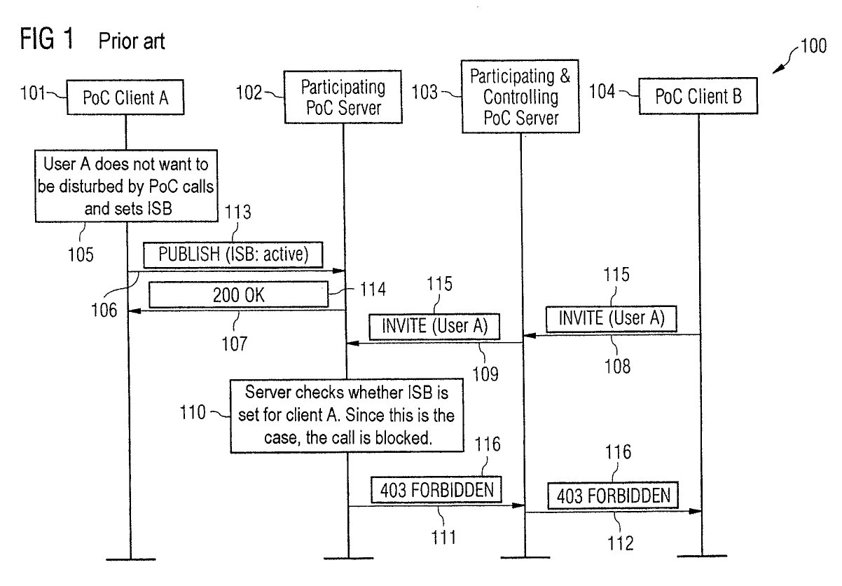

A user of PoC has the possibility of activating so-called Incoming Session Barring (ISB) in the communication network which provides the PoC communication service. In this case, all PoC calls addressed to the user, that is to say all invitations to PoC communications, are rejected. A corresponding message flow is shown in FIG. 1.

FIG. 1 shows a message flow diagram 100.

Participants in the message flow shown in FIG. 1 are a first PoC client unit 101, a participating PoC server 102, a participating and controlling PoC server 103 and a second PoC client unit 104.

In 105, the user of the first PoC client unit 101 does not wish to receive any PoC calls and correspondingly sets on the communication terminal used by him, which implements the first PoC client unit 101, for ISB to be activated.

In 106, a unit of the communication network which provides the PoC communication service for the user of the first PoC client unit 101, the participating PoC server 102 in the present case, is signaled that ISB is to be activated. This is done by means of a PUBLISH message 113.

In 107, the participating PoC server 102 sends a 200 OK message 114 to the first PoC client unit 101 as confirmation. In 108, the user of the second PoC client unit 104 wishes to invite the user of the first PoC client unit 101 to a PoC communication. Accordingly, the second PoC client unit 104 sends an INVITE message 115 in 108 to the participating and controlling PoC server 103 which is forwarded by the latter in 109 to the participating PoC server 102 (which is responsible for the first PoC client unit 101, to illustrate).

In 110, the participating PoC server 102 checks whether ISB is set, that is to say activated, for the first PoC client unit 101. Since this is the case, the invitation to a PoC communication is rejected or, in other words, blocked.

Correspondingly, the participating PoC server 102 sends in 111 a 403 FORBIDDEN message 116 to the participating and controlling PoC server 103 which forwards the 403 FORBIDDEN message 116 to the second PoC client unit in 112 so that the user of the second PoC client unit 104 can be informed that the invitation to the PoC communication has been rejected.

The message flow shown in FIG. 1 is provided in accordance with the specifications of the Open Mobile Alliance (OMA).

A user of PoC also has the possibility of defining a so-called reject list and of signalling this to the communication network which provides the PoC communication service. A reject list is a list of users of PoC (or of the PoC client units used by these users, respectively). All PoC calls addressed to the user who has defined the reject list (or to the PoC client unit used by him), and which were initiated by a user who is listed on the reject list, are rejected. The corresponding message flow is similar to that shown in FIG. 1.

Apart from PoC, there are also other communication services which have the functionality that a user can have all calls (or the calls from a defined group of users) addressed to the user (for example calls or invitations to communication sessions) blocked at the level of the communication network which provides the respective communication service.

Apart from the functionality of an ISB, described above, the functionality that a first user can request a second user to set up a call (for example a voice communication link) to the first user, is also available in some communication services. This is usual, for example, in normal voice telephony and it is also called callback function. In PoC communication systems, the request for a callback is also called Instant Personal Alert.

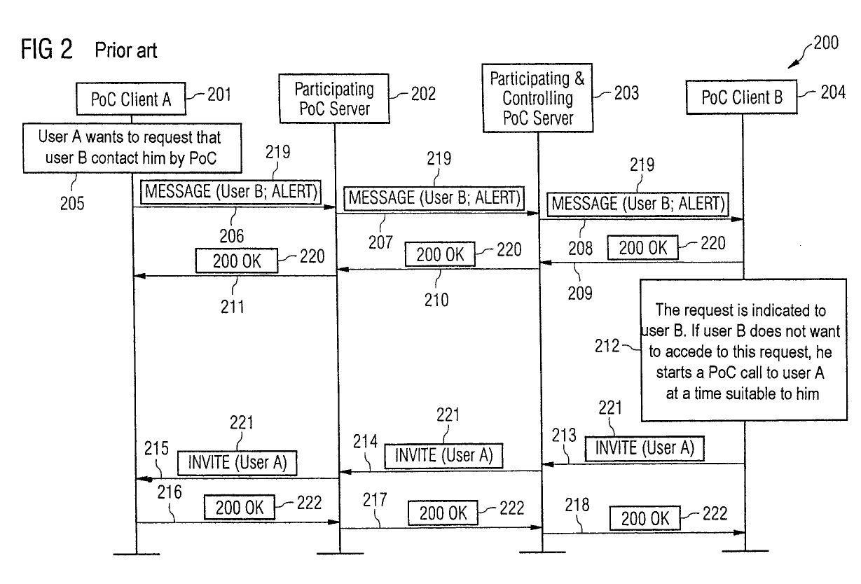

This functionality is also available in PoC. A corresponding message flow is shown in FIG. 2.

FIG. 2 shows a message flow diagram 200.

Analogously to FIG. 1, participants in the message flow shown are a first PoC client unit 201, a participating server 202, a participating and controlling PoC server function 203 and a second PoC client unit 204.

In 205, the user of the first PoC client unit 201 wishes to request the user of the second PoC client unit 204 to contact him by means of PoC, that is to say invite him to a PoC communication.

Accordingly, the first PoC client unit 201, in 206, sends a MESSAGE message 219 to the participating PoC server 202. The MESSAGE message 219 is designed according to the SIP (Session Initiation Protocol) and the format of the content of the MESSAGE message 219 is specified for PoC. To illustrate, the MESSAGE message 219 is forwarded by means of the respective participating PoC servers, that is to say it is forwarded, in this case in 207, from the participating PoC server 202 to the participating and controlling PoC server 203 and finally forwarded by the latter to the second PoC client unit 204 in 208.

In 209, the second PoC client unit 204 sends as confirmation a 200 OK message 220 which is forwarded to the first PoC client unit 201 in 210 and 211 analogously to the MESSAGE message 219.

In 212, the request is indicated to the user of the second PoC client unit 204. In the present case, it is assumed that the user of the second PoC client unit 204 wishes to accede to the request.

Accordingly, the second PoC client unit 204, in 213, sends an INVITE message 221 which is forwarded to the first PoC client unit 201 in 214 and 215, analogously to the MESSAGE message 219. In 216, the first PoC client unit 201, as confirmation, sends a 200 OK message 222 which is also forwarded to the second PoC client unit 204 in 217 and 218 analogously to the MESSAGE message 219.

The user of the second PoC client unit 204 is enabled to accede to the request, for example by a simple operation, and, to illustrate, to perform a direct callback to the user of the first PoC client unit 201.

The combination of the functionality of incoming session barring, explained with respect to FIG. 1, and the functionality of requesting a callback, explained with respect to FIG. 2, can lead to disadvantages, however. For example, a user is participating in a meeting and activates Incoming Session Barring at the beginning of the meeting so that he cannot be disturbed (by calls) during the meeting. During the meeting, however, the user urgently requires information from a field service colleague who is currently with a customer. The user, therefore, sends an Instant Personal Alert to the field service colleague, i.e. the request for the field service colleague to contact the user by means of PoC (callback) as soon as the field service colleague has time, for example is undisturbed. A brief time after the transmission of the Instant Personal Alert, the field service colleague has time and initiates a PoC call to the user. However, since the user has activated ISB at the beginning of the meeting and has forgotten to deactivate it in order to enable the field service colleague to perform the corresponding callback, the PoC call of the field service colleague is blocked.

Even if the user were to remember and deactivate ISB so that the callback of the field service colleague would be made possible, the disadvantage would occur that the user could then be reached again by means of PoC by all other users and would possibly be unintentionally disturbed during the meeting. In this case, it would be required that the user reactivates ISB after the callback of the field service colleague.

The application described indicates that a simultaneous use of the ISB functionality and of the callback functionality leads to disadvantages or unwanted behavior of the PoC communication service. When ISB is activated, an Instant Personal Alert (request for callback) is not only meaningless but creates the illusion to the user of the existence of a functionality which does not exist in this case. In the above example, the user thus relies on the field service colleague to call him back but this is not possible.

A server is provided which has a decision circuit which decides, on the basis of a conflict information provided to the server, which specifies whether there is a conflict between a first request message sent out by a first client and a second request message sent out by the first client, whether an invitation to a communication session from a second client, which is directed to the first client, is forwarded, wherein the first request message specifies that no invitations by the second client to communication sessions, which invitations are directed to the first client, should be forwarded to the first client and the second request message specifies that the second client should invite the first client to a communication session.

According to an exemplary embodiment of the invitation, improved parallel use of Incoming Session Barring and of the callback functionality is made possible.

According to an exemplary embodiment of the invention, a client is provided including a sender which sends out a first request message which specifies that no invitations from another client to communication sessions, which invitations are directed to the client, should be forwarded to the client, and which sends out a second request message which specifies that the other client should invite the first client to a communication session, and a conflict information determining unit which determines conflict information which specifies whether there is a conflict between the first request message and the second request message.

Furthermore, a method for operating a server and a method for operating a client according to the server described above and the client described above, respectively, are provided.

To illustrate, a possibility is created to avoid the problem that a user requests (by means of a client used by him, also called client unit) a callback (telephone call, invitation to PoC session etc.) from a further user although callbacks are blocked by the further user, for example due to a blacklist defined by the user, on which the further user is listed, or because the user has determined at present that no calls (invitations to PoC sessions etc.) should be switched through to his PoC client unit (as in the case of PoC with activation of ISB (Incoming Session Barring)). On the basis of the finding that such a conflict is occurring, the server (also called server unit), that is to say a unit of the communication network which provides the corresponding communication service (for example voice telephony or PoC (Push-to-talk-over-Cellular)) decides whether the requested callback of the further user should be allowed, for example within a certain period, that is to say should not be blocked in the communication network.

In the case of a blacklist, for example, the further user is excepted from the blacklist for a certain period which is determined, for example, by the user. If the user has determined that no calls should be switched through to his PoC client unit, an exception rule can be analogously defined for the further user so that callbacks from the user are allowed within a particular period, that is to say are switched through by the communication network. To illustrate, the blocking of incoming invitations to communication sessions initiated by one (or more) particular users is automatically stopped.

The conflict can be resolved by using the invention so that the functionalities of a request for callback and of blocking of incoming calls (or invitations to communication sessions) can be used reliably and safely. In particular, a user can rely on the correct operation of these functionalities.

The communication between the client which is implemented, for example, by means of a mobile radio terminal, and the server or the communication network (for example a mobile radio network) can take place, for example, according to HTTP (Hypertext Transfer Protocol), H.323, WAP (Wireless Application Protocol) or SIP (Session Initiation Protocol).

The further embodiments of the invention described in conjunction with the server correspondingly also apply to the client, the method for operating a server and the method for operating a client.

In one embodiment, the server has a conflict information receiver which receives the conflict information from the first client. In another embodiment, the server has a determining device which determines the conflict information.

The fact that there is a conflict (between the first request message and the second request message) can thus be determined by the server or by the client. The server can also be set up, when it detects that there is a conflict, to signal this to the first client.

The server can have a period information receiver which receives from the first client the specification of a period. The server can correspondingly decide, if there is a conflict between the first request message and the second request message, that the invitation to the communication session from the second client, which is directed to the first client, is forwarded if the invitation has been sent out within the specified period.

The period is specified, for example, by the user of the first client, for example a PoC client. The user thus retains full control over this functionality.

The second request message specifies, for example, that the second client should set up a voice communication link, a video telephony communication link or a text message communication link to the first client.

The second request message can also specify that the second client should invite the first client to a PoC communication session.

The first request message can signal, for example, Incoming Session Barring. The client can transmit the conflict information to a server.

In one embodiment, the client decides on the basis of the conflict information whether an invitation to a communication session from the further client, which is directed to the first client, should be forwarded to the first client and signals the result of the decision to the server.

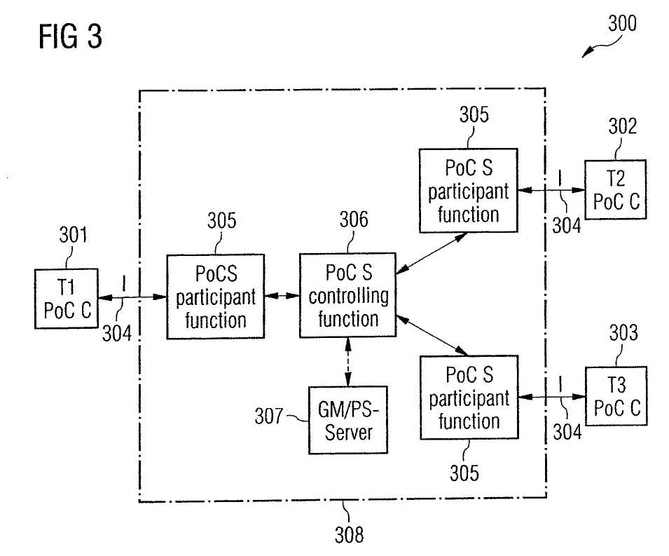

FIG. 3 shows a communication system 300 according to an exemplary embodiment of the invention.

A first PoC client unit 301 (PoC client), a second PoC client unit 302 and a third PoC client unit 303 are coupled to in each case one PoC server participant function 305 by means of one interface 304 in each case. The PoC server participant functions 305 are coupled to a PoC server controlling function 306. The PoC client units 301, 302, 303 are in each case implemented by means of a communication terminal, for example by means of a mobile radio terminal.

The PoC server controlling function 306 is coupled to a GM/PS (Group Management/Presence) server 307. The GM/PS server 307 has the functionality of a GM server and of a PS server (in the text which follows, reference is made to the functionality of a GM server or of a PS server depending on context). The GM/PS server can also be arranged separately in the form of a GM server and of a PS server. In its functionality as GM server, the GM/PS server administers user settings relating to group management, for example, a blacklist defined by a user of a PoC client unit 301, 302, 303 can be administered by the GM/PS server 307 (see below). In its functionality as GM server, the GM/PS server administers user settings which relate to the “presence”, i.e. the availability, of users of the PoC client units 301, 302, 303. For example, the GM/PS server 307 administers the information about the PoC client units 301, 302, 303, for which ISB is currently activated.

The interfaces 304 are provided, for example, by means of the RAN (Radio Access Network), the core network (CN) and the IMS (Internet Protocol based Multimedia Subsystem) of a UMTS (Universal Mobile Telecommunication System) communication system or by means of a GSM (Global System for Mobile Communication) communication system.

However, the interfaces 304 can also be provided, for example, by means of a PSTN (Public Switched Telephone Network) communication network.

The PoC client units 301, 302, 303 are in each case integrated in a communication terminal which is set up in accordance with the respective interface 304, for example as mobile radio terminal for communication in accordance with the UMTS standard, the GSM standard, the GPRS (General Packet Radio Service) standard or another mobile radio communication standard.

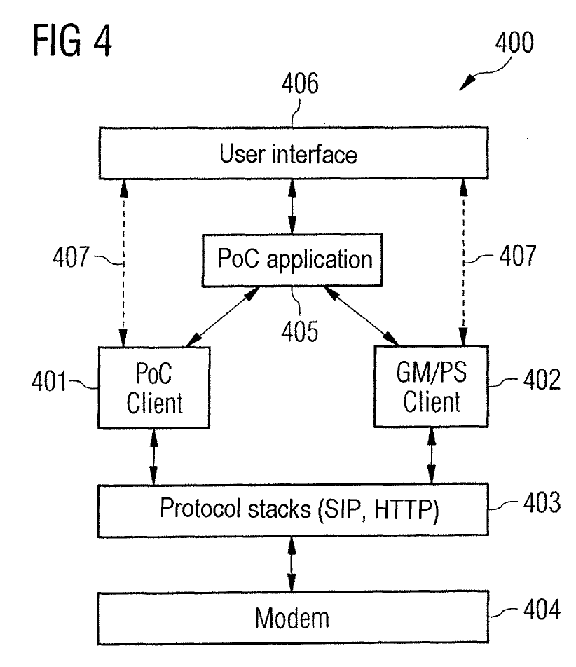

Apart from their function as PoC client units, the communication terminals implement other functions as is explained with respect to FIG. 4 in the text which follows.

FIG. 4 shows a diagrammatic view of a communication terminal 400 according to an exemplary embodiment of the invention.

As mentioned, the communication terminal 400 implements a PoC client unit 401 which is set up and arranged in accordance with the first PoC client unit 301, the second PoC client unit 302 and the third PoC client unit 303. To illustrate, the PoC client unit 401 fulfills the “pure” PoC functionalities of the communication terminal, it is responsible, for example, for exchanging messages with the corresponding PoC server participant function 305 (for example for initiating a PoC call or for sending an instant personal alert).

The communication terminal 400 also implements a GM/PS client unit 402. The GM/PS client unit 402 fulfills the functionalities relating to the setting of settings specific to the user of the communication terminal 401 in the PoC communication network 308. In the case of the determination of a reject list (that is to say a blacklist), the GM/PS client unit operates as GM (Group Management) client unit. If ISB is activated, the GM/PS client unit operates as PS (presence) client unit.

The PoC server participant function 305, the PoC server controlling function 306 and the GM server 307 are part of a PoC communication network 308 which provides the PoC communication service of the first PoC client unit 301, the second PoC client unit 302 and the third PoC client unit 303.

For the required communication with the PoC communication network 308, the PoC client unit 401 and the GM/PS client unit 402 access protocol stacks 403, for example protocol stacks according to the SIP (Session Initiation Protocol) or the HTTP (Hypertext Transfer Protocol). Furthermore, a modem 404 provides the communication with the PoC communication network 308.

A PoC application 405 is installed on the communication terminal 400 which controls the interaction between the PoC client unit 401 and the GM/PS client unit 402 as is described below. In the terminal-based method explained below, the PoC application 405 deals with (detects and bypasses), for example, the conflict which occurs when the callback functionality is used when ISB is activated.

The PoC application 405 receives user inputs of the user of the communication terminal 400 by means of a user interface 406. The dashed lines 407 indicate that there can also be a direct interaction between the PoC client unit 401 and the GM/PS client unit 402 with the user by means of the user interface 406. In particular, all interactions between the PoC application 405 and the user interface 406 (or the user, respectively), described in the text which follows, can also take place between the PoC client unit 401 or the GM/PS client unit 402, respectively, and the user interface 406 (or the user, respectively).

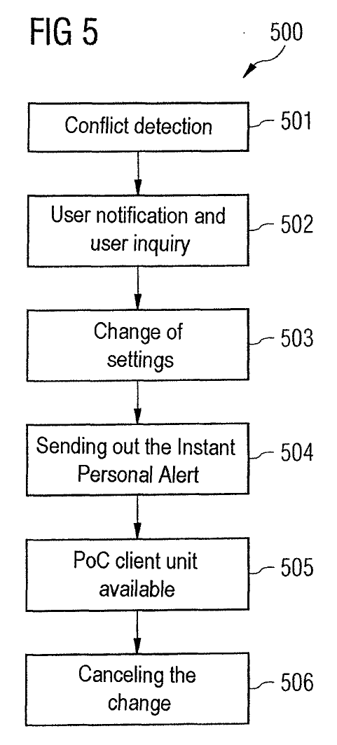

In the text which follows, a method according to an exemplary embodiment of the invention which, to illustrate, is terminal-based, is explained with reference to FIG. 5. In particular, this has the advantage that it is not required to implement in the PoC communication network 308 a functionality which is new with respect to conventional PoC communication networks. In particular, the new functionality does not need to be standardized.

FIG. 5 shows a flow diagram 500 according to an exemplary embodiment of the invention.

It is assumed that the PoC client unit 401 transmits to the corresponding PoC server participant function 305 a message which signals an Instant Personal Alert for a further PoC client unit. To illustrate, the PoC client unit 401 (or the corresponding user, respectively) requests a callback of the further PoC client unit (or of the corresponding user, respectively). In 501, it is checked whether there is a conflict since the GM/PS client unit 402 has activated ISB and accordingly, PoC calls addressed to the PoC client unit 401 should be rejected, in principle, or since the further PoC client unit (or its user) is listed on a blacklist (reject list) defined by the user of the communication terminal 400 by means of the GM/PS client unit 402 and, accordingly, PoC calls initiated by the further PoC client unit and addressed to the PoC client unit 401 should be rejected.

The conflict detection, that is to say checking whether there is a conflict, can be performed by the PoC communication system 308 or by the PoC application 405 itself.

If conflict detection is performed by the PoC communication system 308, the corresponding PoC server participant function 305, after receiving the Instant Personal Alert from the PoC client unit 401, checks whether there is a conflict. This is possible since the PoC server participant function 305 can inform itself by means of the GM/PS server 307 whether ISB is currently activated for the PoC client unit 401 (that is to say the GM/PS client unit 402 which has activated ISB), and whether the further PoC client unit is listed on a blacklist defined by the GM/PS client unit 402 (and correspondingly transmitted to the GM/PS server 307).

If the PoC server participant function 305 detects that there is a conflict, it sends a corresponding error message to the first PoC client unit 401. The first PoC client unit 401 thereupon informs the PoC application 405 about the occurrence of a conflict.

If conflict detection is performed by the communication terminal 400 itself, the PoC application 405 checks the current settings, that is to say whether ISB is activated or whether a blacklist is defined, when the user wishes to send an Instant Personal Alert, and can thus determine whether there is a conflict. The PoC application 405 can interrogate the GM/PS client unit 402 for the current settings or they are signaled to it by the GM/PS client unit 402.

Independently of whether the conflict detection is performed by the PoC communication network 308 or by the PoC application 405, the PoC application 405 is thus informed at the end of 501 whether there is a conflict. In the text which follows, it is assumed that there is a conflict.

In 502, the PoC application 405 informs the user of the communication terminal 400 that there is a conflict and proposes a period to the user, or enables the user to select a period, for which the blocking, that is to say the automatic rejection, of PoC calls addressed to the PoC client unit 401 and initialized by the further PoC client unit should be canceled, that is to say switched off. In the present case, it is assumed that the user confirms this to the PoC application 405 and selects a corresponding period.

In 503, the PoC application 405 changes the settings (that is to say the state of ISB activation and/or the blacklist) applicable to the PoC client unit 401 in the GM/PS server 307 by means of the GM/PS client unit 402. Changing the settings is explained in greater detail below by means of an example. The PoC server participant function 405 is automatically informed about the changed settings by the GM/PS server 307. The settings can be changed in conventional manner or parameter values are additionally signaled which specify for how long the changed settings should be applicable before returning to the previous settings.

The method according to the present exemplary embodiment is terminal-based in the sense that the change of settings is performed by the PoC application 405, that is to say by the communication terminal 400.

In 504, the planned Instant Personal Alert is then signaled. This is done by transmitting a corresponding message from the PoC application 405 by means of the PoC client unit 401 to the PoC server participant function. From there, it is forwarded to the further PoC client unit.

In 505, the PoC client unit 401 can now be reached by the further PoC client unit, that is to say the further PoC client unit can address PoC calls to the PoC client unit 401 without these being blocked.

In 506, the change in settings is canceled, that is to say the original settings are returned to. This can be done in accordance with two variants, depending on how 503 was performed. If the communication terminal 400 has signaled the change in conventional manner in 503, the PoC application 405, after the period specified in 502 has elapsed or after the further PoC client unit has called back, cancels the changes in settings by means of the GM/PS client unit 402 conventionally by corresponding signaling to the PoC communication network 308.

If the communication terminal 400 has signaled parameter values in 503 which specify when to return to the original settings, the PoC communication network 308 returns to the original settings at the time specified by the parameter values signaled.

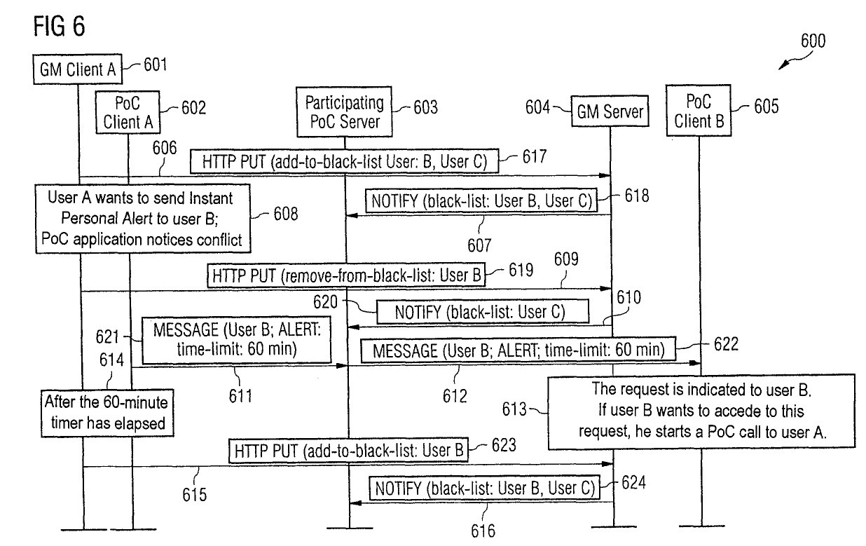

In the text which follows, an example of the method explained with reference to FIG. 5 is explained with reference to FIG. 6.

FIG. 6 shows a message flow diagram 600 according to an exemplary embodiment of the invention.

The message flow shown occurs between a GM client unit 601, a first PoC client unit 602, a participating PoC server 603, a GM server 604 and a second PoC client unit 605 which are arranged according to FIG. 3 and FIG. 4, the GM client unit 601 corresponding to the GM/PS client unit 402 and the first PoC client unit 602 corresponding to the PoC client unit 401. Since a blacklist is used in this example, the GM server 604 is involved which corresponds to the GM/PS server 307 (the GM client unit 601 is analogously involved for this reason).

In 606, the user of the communication terminal which implements the GM client unit 601 and the first PoC client unit 602 sets up a blacklist in its associated GM server 604 by means of its GM client unit 601 by sending a first HTTP PUT message 617. The blacklist is thus known both to the GM server 604 and to the GM client unit 601. Furthermore, in 601, the participating PoC server 603 which is responsible for the user is informed about the blacklist by the GM server 604 by means of a first NOTIFY message 618. The first NOTIFY message 618 is arranged, for example, in accordance with an SIP NOTIFY.

The blacklist has the functionality that all PoC calls addressed to the first PoC client unit 602 and initiated by users (or the PoC client units used by them) who are listed on the blacklist are already blocked in the participating PoC server 603, that is to say that the participating PoC server 603 does not forward these PoC calls to the first PoC client unit 602. The user of the first PoC client unit 602 thus will not notice anything of these incoming PoC calls. The users listed on the blacklist in the present example shall be the user of the second PoC client unit 605 (user B) and a further user (user C).

In 608, the user of the first PoC client unit 602 wishes to send an Instant Personal Alert to the user of the second PoC client unit 605 by means of the PoC application 405. Before the PoC application 405 sends the Instant Personal Alert to the user of the second PoC client unit 605, it asks the GM client unit 601 (which, as explained, is also implemented by the communication terminal 400 in the present case) which users are listed on the blacklist specified by the user of the first PoC client unit.

The PoC application 405 recognizes from this information that sending out an Instant Personal Alert would be meaningless with the current user settings of the user of the first PoC client unit 602 (that is to say the blacklist currently specified) since the attempt of the user of the second PoC client unit 605 of performing a callback in response to the Instant Personal Alert, that is to say attempting to reach the user of the first PoC client unit 602 by means of PoC, would be blocked by the PoC communication network 308 (the participating PoC server 603 in real terms).

The PoC application 405 informs the user of the first PoC client unit 602 about this conflict and (in the present example) proposes to him a period of 30 minutes for which blocking of incoming PoC calls from the user of the second PoC client unit 605 (that is to say initiated by the user of the second PoC client unit 605) should be canceled. The user of the first PoC client unit 602 changes the period, for example, to 60 minutes and confirms this to the PoC application 405.

Accordingly, the PoC application 405 orders the GM client unit 601 to delete the user of the second PoC client unit 605 from the blacklist. The GM client unit 601 accordingly carries this out in 609 by transmitting a second HTTP PUT message 619 to the GM server 604. In 610, the GM server 604 informs the participating PoC server 603 about the change in the blacklist which now only contains the further user “user C”, by means of a second NOTIFY message 620 (according to SIP NOTIFY). The PoC application 405 also starts a 60-minute timer.

According to the alternative explained with reference to FIG. 5, the GM client unit 601, in another embodiment, carries out an action redefined with respect to the conventional procedure at the GM server 604 by transmitting in 609 a parameter to the GM server 604 which specifies that the deletion of the user of the second PoC client unit 605 from the blacklist should last 60 minutes. Accordingly, the deletion would be canceled independently by the GM server 604 after 60 minutes have elapsed (this alternative embodiment is now shown in FIG. 6).

In 611, the first PoC client unit 602 sends the Instant Personal Alert, intended for the user of the second PoC client unit 605, by means of a first MESSAGE message 621 (for example arranged according to SIP MESSAGE) to the participating PoC server 603. The participating PoC server 603 forwards the Instant Personal Alert to the second PoC client unit 605 by means of a second MESSAGE message 622 according to SIP MESSAGE.

As extension compared with conventional Instant Personal Alerts, the Instant Personal Alert can have a parameter which specifies the validity period of the Instant Personal Alert as 60 minutes. This is indicated by means of “time limit: 60 min” in the first MESSAGE message 621 and the second MESSAGE message 622 in FIG. 6. In this case, the second PoC client unit 605 is informed about the time restriction on the possibility of making a callback according to the Instant Personal Alert (and this can be indicated to the user of the second PoC client unit 605).

In 613, the user of the second PoC client unit has the possibility of reaching the user of the first PoC client unit by means of PoC for 60 minutes.

In 614 (the following is not stated in the above-mentioned alternative embodiment), the PoC application 405 orders the GM client unit 601 to reinsert the user of the second PoC client unit 605 in the blacklist after the 60-minute timer has elapsed. In 615, the GM client unit 601 carries out this action by transmitting a second HTTP PUT message 623 to the GM server 604. In 616, the GM server 604 informs the participating PoC server 603 about this new change by means of a third NOTIFY message 624 (according to SIP NOTIFY). The blacklist now has the user of the second PoC client unit 605 “user B” and the further user “user C” again. After the 60 minutes (of the validity period) have elapsed, a PoC call addressed to the user of the first PoC client unit 602 by the user of the second PoC client unit 605 is thus blocked again.

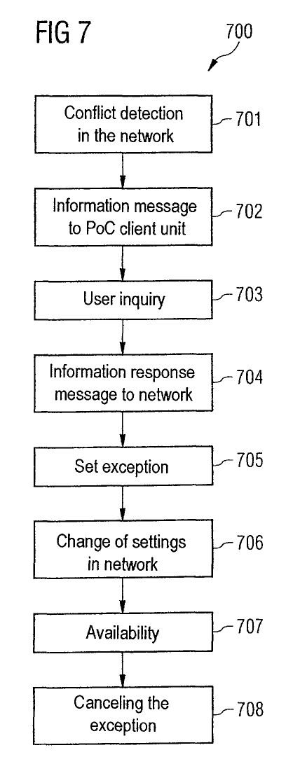

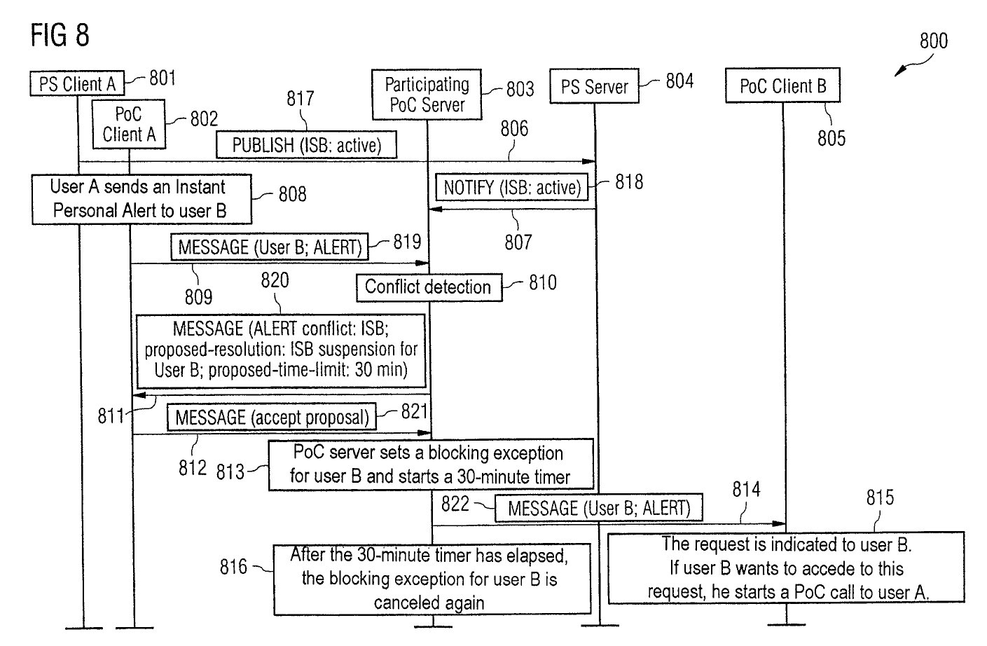

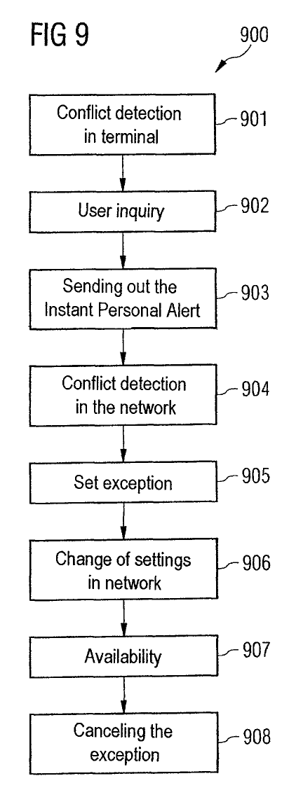

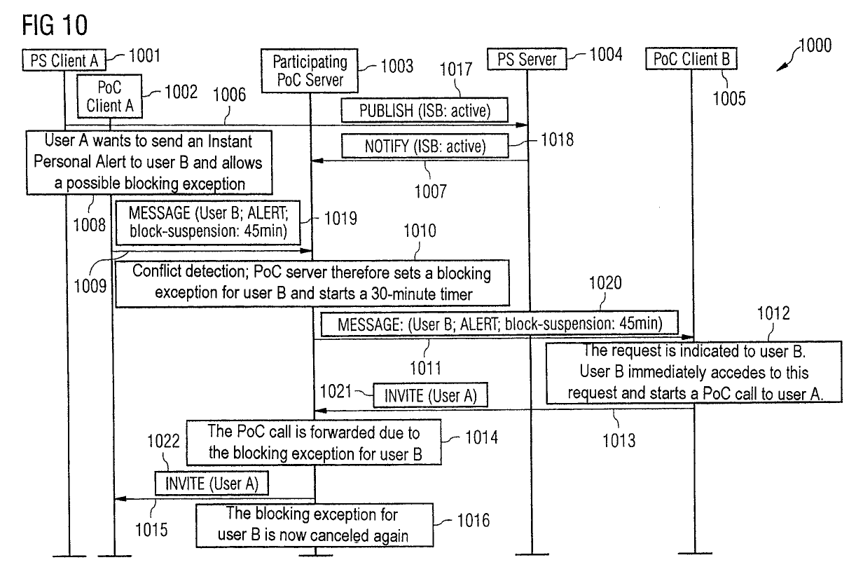

In the text which follows, methods according to further embodiments which, to illustrate, are network-based methods, are explained with reference to FIG. 7, FIG. 8, FIG. 9 and FIG. 10. The exemplary embodiment explained with reference to FIG. 7 and FIG. 8 has the advantage that an Instant Personal Alert is used in the form already standardized. In this exemplary embodiment, there is thus compatibility with PoC communication networks already existing. In the embodiment explained with reference to FIG. 9 and FIG. 10, the Instant Personal Alert, to illustrate, is extended by a parameter which specifies that the blocking of calls is canceled by the user to which the Instant Personal Alert is directed and specifies a period for which this cancellation of blocking is valid.

FIG. 7 shows a flow diagram 700 according to an exemplary embodiment of the invention.

The concept forming the basis of the method explained in the text which follows can be seen in that the participating PoC server 305 determines a conflict and inquires from the communication terminal 400 which implements the first PoC client unit 301 whether an exception from current user settings for a user to which an Instant Personal Alert is to be transmitted should be set in the participating PoC server 305.

It is assumed that the PoC client unit 301 transmits an Instant Personal Alert (on request by the user of the first PoC client unit 301) which is addressed to a further user (or the PoC client unit used by the further user, respectively).

In 701, a conflict detection is performed in the PoC communication network 308. Since the current user settings (ISB and blacklist) by the GM/PS server 307 are known to the PoC server participant function 305, it checks whether there is a conflict after receiving the Instant Personal Alert from the first PoC client unit 301. If this is so, the process continues with 702.

In the present case, it is assumed that there is a conflict, that is to say the further user to which the Instant Personal Alert is addressed is listed on a blacklist specified for the first PoC client unit 301, or ISB is activated for the first PoC client unit 301.

In 702, the PoC server participant function 305 transmits an information message to the first PoC client unit 301 in order to inform it about the existing conflict. Furthermore, the PoC server participant function 305 proposes by means of the information message to cancel the blocking rule for the further user, that is to say the setting that PoC calls initiated by the further user and addressed to the user of the first PoC client unit 301 are blocked, for a certain period. The PoC client unit 301 accordingly informs the PoC application 405 of this.

In 703, a user interrogation relating to a temporary exception (from the currently valid user settings) is performed. The PoC application 405 asks the user whether he agrees to cancel the blocking rule for a certain period for the further user. If the user agrees, he can also select another period than the period proposed.

In 704, the PoC application 405 informs the PoC client unit 301 about the response of the user. The PoC client unit 301 accordingly transmits an information response message to the PoC server participant function 305 which, depending on how 703 was carried out, contains the specification of a period selected by the user.

In 705, the exception is correspondingly set, that is to say the PoC server participant function 305 changes (overwrites) the blocking rule for the further user. Furthermore, the Instant Personal Alert is forwarded to the PoC client unit used by the further user.

As an option, a change in the user settings is performed in the PoC communication network 308 in 706. In this process, the PoC server participant function 305 changes the user settings (status of ISB activation and/or blacklist) in the GM/PS server 307 for the period for which the blocking rule is to be canceled for the further user. This can be done by the PoC server participant function 305 changing the user setting and canceling this change after the period has elapsed or by the PoC server participant function 305 changing the user settings in the GM/PS server 307 and, in doing so, signaling the GM/PS server 307 with the period after which the GM/PS server 307 should automatically cancel the change again.

Process 706 is optional since the exception of the blocking rule for the further user is only valid for the PoC communication service (Instant Personal Alert is a feature of the PoC communication service), and the PoC server participant function 305 is itself informed about the exception from the blocking rule and, therefore, the user settings do not necessarily need to be changed explicitly in the GM/PS server 307.

In 707, the PoC client unit used by the further user can now reach the first PoC client unit 301 without the PoC calls initiated by the further user (or its PoC client unit) and addressed to the first PoC client unit 301 being blocked by the PoC server participant function 305.

The exception is canceled in 708. This occurs, for example, when the period has elapsed or when a callback has taken place. As explained above, canceling the exception is performed by the PoC server participant function 305 or the GM/PS server 307 depending on embodiment.

In the further text, an example of the method explained with reference to FIG. 7 is described with reference to FIG. 8.

FIG. 8 shows a message flow diagram 800 according to an exemplary embodiment of the invention.

Since ISB is used in this example, a PS client unit 801 corresponding to the GM/PS client unit 402, and a PS server 804 corresponding to the GM/PS server 307, are involved in the message flow shown. Furthermore, a first PoC client unit 802 corresponding to the PoC client unit 401 (and thus to the first PoC client unit 301), a participating PoC server 803 corresponding to the corresponding PoC server participant function 305 and a second PoC client unit 805 corresponding to the second PoC client unit 302 are involved in the message flow shown.

In 806, the first PoC client unit 802 activates ISB by means of its associated PS client unit 801 by the PS client unit 801 transmitting a PUBLISH message 817 (for example according to SIP PUBLISH) to the PS server 807. Accordingly, ISB is activated in the PS server 804 for the first PoC client unit 802. In 807, the PS server 804 informs the participating PoC server 803 about the ISB activated for the first PoC client unit by means of a NOTIFY message 818 (according to SIP NOTIFY). As long as ISB is activated for the first PoC client unit 802, all PoC calls addressed to the first PoC client unit 802 are blocked by the participating PoC server 803.

In 808, the user of the first PoC client unit 802 causes an Instant Personal Alert to be sent to the user of the second PoC client unit 805 (user B). For this purpose, the user of the first PoC client unit 802 sends an Instant Personal Alert for the user of the second PoC client unit 805 with the aid of the PoC application 405 and the first PoC client unit 802 to the participating PoC server 803 by means of a first MESSAGE message 819 (according to SIP MESSAGE) in 809.

In 810, the participating PoC server 803, which, due to the NOTIFY message 818 is informed that ISB is activated for the first PoC client unit 802, after receiving the Instant Personal Alert (that is to say after receiving the first MESSAGE message 819) detects that there is a conflict.

If it were not ISB which is activated for the first PoC client unit 802 but a reject list (blacklist) containing the user of the second PoC client unit 805 were defined, the participating PoC server 803 would detect the corresponding conflict by comparing the entries in the blacklist with the intended receiver of the Instant Personal Alert.

Since it has detected a conflict, the participating PoC server 803 sends an information message in the form of a second MESSAGE message 820 (according to SIP MESSAGE) to the first PoC client unit 802 by means of which it informs the first PoC client unit 802 about the conflict (indicated by “Alert Conflict: ISB” in FIG. 8). Furthermore, the participating PoC server 803 proposes by means of the second MESSAGE message 820, for example, to cancel the blocking rule for the user of the second PoC client unit 805 for 30 minutes, that is to say not to allow the participating PoC server 803 to block PoC calls initiated by the user of the second PoC client unit 805 and addressed to the first PoC client unit 802 for the duration of 30 minutes (this is indicated in FIG. 8 by “proposed resolution: ISB suspension for user B; proposed time limit: 30 min”).

Following this, the first PoC client unit 802 informs the PoC application 405 accordingly about the conflict and the proposal. In the present case, it is assumed that the user of the first PoC client unit 802 accepts the proposal. Accordingly, the PoC application 405 gives a positive answer signaling that the signal is accepted by means of the first PoC client unit 802 and a fourth MESSAGE message 821 (according to SIP MESSAGE) in 812.

In 813, the participating PoC server 803 thereupon sets a blocking exception for the user of the second PoC client unit 805, that is to say cancels the blocking rule for the user of the second PoC client unit 805 and starts a 30-minute timer in 813.

Furthermore, the Instant Personal Alert is forwarded to the second PoC client unit 805 by means of a fifth MESSAGE message 822 (according to SIP MESSAGE) in 814.

In 815, the user of the second PoC client unit 805 then has the possibility of reaching the user of the first PoC client unit 802 by means of PoC, that it to say to successfully transmit a PoC call to the first PoC client unit 802.

In 816, the blocking exception for the user of the second PoC client unit is canceled again after the 30-minute timer has elapsed in the participating PoC server 803, that is to say that PoC calls initiated by the user of the second PoC client unit and addressed to the first PoC client unit 802 are again blocked by the participating PoC server 803.

In the text which follows, a further illustratively network-based method is explained with reference to FIG. 9.

FIG. 9 shows a flow diagram 900 according to an exemplary embodiment of the invention.

The concept forming the basis of the method explained in the text which follows can be seen in that the communication terminal, when sending an Instant Personal Alert, additionally signals a parameter which has the effect that the participating PoC server, in the case of a conflict, can set an exception without inquiry at the corresponding PoC client unit.

In 901, a conflict detection is optionally performed in the communication terminal 400. Since the current user settings (ISB and/or blacklist) are known to the PoC application 405 by means of the GM/PS client unit 402, it can check with each Instant Personal Alert which the user of the communication terminal wishes to send out whether there is a conflict. If this is the case, which is assumed in the text which follows, the sequence is continued with 902.

In 902, a user inquiry for a temporary exception regulation is performed. Before the Instant Personal Alert is sent out by the communication terminal 400, the PoC application 405 asks the user of the communication terminal 400 whether a callback should be switched through (that is to say should not be blocked) in every case and for how long a corresponding exception rule (exception from the blocking rule) should be valid. Since this inquiry can always be performed, that is to say independently of whether there is a conflict, 901 is optional.

In 903, the Instant Personal Alert is sent out. For this purpose, the PoC client unit 401 sends the Instant Personal Alert to the corresponding PoC server participant function 305, additionally signaling that a callback of the further user to which the Instant Personal Alert is addressed should be switched through in every case in the period specified by the user of the communication terminal 400 in 902 (assuming that the user has correspondingly answered the user inquiry in 902), independently of what user settings exist at the moment.

In 904, a conflict detection is performed in the PoC communication network 308. After receiving the Instant Personal Alert from the PoC client unit 401, the PoC server participant function 305, which knows the current user settings (ISB and/or blacklist) from the GM/PS server 307, checks whether there is a conflict. In the present case, a conflict occurs and the process continues with 905. In the case where there is no conflict, the Instant Personal Alert is simplify forwarded to the corresponding user. 905 to 908 correspond to 705 to 708, it being assumed, as mentioned, that it has been signaled in 903 that a callback should be switched through in every case within the specified period.

In the text which follows, an example of the method explained with reference to FIG. 9 is described with reference to FIG. 10.

FIG. 10 shows a message flow diagram 1000 according to an exemplary embodiment of the invention.

Analogously to the message flow shown in FIG. 8, the message flow shown in FIG. 10 takes place between a PS client unit 1001, a first PoC client unit 1002, a participating PoC server 1003, a PS server 1004 and a second PoC client unit 1005. Analogously to 806 in FIG. 8, the first PoC client unit 1002 activates ISB by means of a PUBLISH message 1017 in 1006, about which the PS server 1004 informs the participating PoC server 1003 by means of a NOTIFY message 1018 in 1007 analogously to 807.

In 1008, the user of the first PoC client unit 1002 wishes to send an Instant Personal Alert to the user of the second PoC client unit 1005 by means of the PoC application 405. The PoC application 405 thereupon optionally interrogates the PS client unit 1001 for the current user settings. In the present case, the PoC application is thus informed by the PS client unit 1001 that ISB is currently activated. The PoC application 405 thereupon asks the user of the first PoC client unit 1002 whether the callback of the user of the second PoC client unit 1005 (as requested by means of the Instant Personal Alert) should be allowed in every case, that is to say should not be blocked (that is to say that the corresponding PoC call should not be blocked) even though ISB is activated. (The case where the user of the second PoC client unit 1005 is on a blacklist which is defined for the PoC client unit 1002 is dealt with analogously). Furthermore, the PoC application 405 asks how long the exception should be valid if an exception of the blocking rule has to be set for the user of the second PoC client unit 1005 since a callback should be allowed in every case.

In 1009, the PoC application 405 sends out the desired Instant Personal Alert for the user of the second PoC client unit 1005 by means of the first PoC client unit 1002 by means of a first MESSAGE message 1019 (according to SIP MESSAGE) to the participating PoC server 1003, and it is also signaled by means of the first MESSAGE message 1019 that the blocking rule should be canceled for 45 minutes (in the case of a conflict). This is indicated by “block suspension: 45 min” in FIG. 10.

In 1010, the participating PoC server 1003, which is informed about ISB being activated for the first PoC client unit 1002 by the NOTIFY message 1018 detects the conflict after receiving the Instant Personal Alert. In the case where it is not ISB which is activated but a blacklist containing the user of the second PoC client unit 1005 is defined for the first PoC client unit 1002, the participating PoC server 1003 detects the conflict by comparing the entries in the blacklist with the intended receiver of the Instant Personal Alert.

The participating PoC server 1003 sets a blocking exception (that is to say an exception to the blocking rule) for the user of the second PoC client unit 1005 and starts a 45-minute timer. In 1011, the Instant Personal Alert is then forwarded to the second PoC client unit 1005 by means of a second MESSAGE message 1020 (according to SIP MESSAGE), and it is signaled that the blocking rule is canceled for 45 minutes (indicated by “block suspension: 45 min” in FIG. 10).

In 1012, reception of the Instant Personal Alert is indicated to the user of the second PoC client unit 1005. In the present case, it is assumed that the user of the second PoC client unit 1005 wishes to make a callback. The second PoC client unit 1005 accordingly sends a first INVITE message 1021 to the participating PoC server 1003 by means of a PoC server participant function 305 (not shown) associated with the PoC client unit 1005. The first INVITE message 1021 is arranged, for example, according to an SIP INVITE.

It is assumed that the 45-minute timer has not yet elapsed at the time of reception of the first INVITE message 1021 by the participating PoC server 1003 and the blocking exception accordingly is still valid for the user of the second PoC client unit 1005. The participating PoC server 1003 thus decides in 1014 to forward the first INVITE message 1021 which happens by means of a second INVITE message 1022 transmitted to the first PoC client unit 1022 in 1015.

In 1014, the blocking exception for the user of the second PoC client unit 1005 is canceled due to the callback made, that is to say PoC calls initiated by the second PoC client unit 1005 and addressed to the first PoC client 1002 are blocked by the participating PoC server 1003. In another embodiment, the blocking exception is only canceled when the 45-minute timer has elapsed, in 1016.

The foregoing description has been presented for purposes of illustration and description. It is not intended to be exhaustive or to limit the invention to the precise form disclosed, and obviously many modifications and variations are possible in light of the disclosed teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A server, comprising:
a decision circuit configured to decide, based on conflict information provided to the server, which specifies whether there is a conflict between first and second request messages sent by a first client, whether an invitation to participate in a communication session sent by a second client and directed to the first client, is forwarded to the first client,
wherein the first request message specifies that no invitations sent by the second client to the first client to participate in a communication session should be forwarded to the first client, and the second request message specifies that the second client should invite the first client to participate in a communication session.

2. The server as claimed in claim 1, further comprising a conflict information receiver which receives the conflict information from the first client.

3. The server as claimed in claim 1, further comprising a determining device which determines the conflict information.

4. The server as claimed in claim 1, further comprising a period information receiver, which receives from the first client a specification of a period, and wherein the server, if there is a conflict between the first and second request messages, decides that the invitation to participate in the communication session sent by the second client to the first client is forwarded to the first client if the invitation has been sent by the second client within the specified period.

5. The server as claimed in claim 1, wherein the second request message specifies that the second client should set up a voice communication link, a video telephony communication link, or a text message communication link to the first client.

6. The server as claimed in claim 1, wherein the second request message specifies that the second client should invite the first client to participate in a PoC communication session.

7. The server as claimed in claim 6, wherein the first request message signals Incoming Session Barring.

8. A method of operating a server, comprising:
deciding, based on conflict information which specifies whether there is a conflict between first and second request messages sent by a first client, whether an invitation to a communication session sent by the second client and directed to the first client is forwarded to the first client,
wherein the first request message specifies that no invitations sent by the second client to the first client to participate in a communication session should be forwarded to the first client, and the second request message specifies that the second client should invite the first client to participate in a communication session.

9. A client, comprising:
a sender configured to send a first request message which specifies that no invitations from another client to the client to participate in a communication session should be forwarded to the client, and to send a second request message which specifies that the other client should invite the first client to participate in a communication session; and
a conflict determining unit configured to determine, based on conflict information, whether there is a conflict between the first request message and the second request message.

10. The client as claimed in claim 9, wherein the sender transmits the conflict information to a server of the communication system.

11. The client as claimed in claim 9, further comprising a decision circuit configured to decide, based on the conflict information, whether an invitation to a participate in a communication session sent from the other client and directed to the client should be forwarded to the client, and to signal the result of the decision to a server.

12. A method for operating a client, comprising:
sending a first request message specifying that no invitations to participate in a communication session sent from another client, should be forwarded to the client;
sending a second request message specifying that the other client should invite the client to participate in a communication session; and
determining, based on conflict information, whether there is a conflict between the first and second request messages.

13. A server, comprising:
a decision means for deciding, based on conflict information provided to the server, which specifies whether there is a conflict between first and second request messages sent by a first client, whether an invitation to participate in a communication session sent by a second client and directed to the first client, is forwarded to the first client; and
a conflict information receiving means for receiving the conflict information from the first client,
wherein the first request message specifies that no invitations sent by the second client to the first client to participate in a communication session should be forwarded to the first client, and the second request message specifies that the second client should invite the first client to participate in a communication session.

14. The server as claimed in claim 13, further comprising a determining means for determining the conflict information.

15. The server as claimed in claim 13, further comprising a period information receiving means for receiving from the first client a specification of a period, and wherein the server, if there is a conflict between the first and second request messages, decides that the invitation to participate in the communication session sent by the second client to the first client is forwarded to the first client if the invitation has been sent by the second client within the specified period.

16. A client, comprising:
a sending means for sending a first request message which specifies that no invitations from another client to the client to participate in a communication session should be forwarded to the client, and for sending a second request message which specifies that the other client should invite the first client to participate in a communication session; and
a conflict determining means for determining, based on conflict information, whether there is a conflict between the first request message and the second request message.

17. The client as claimed in claim 9, further comprising a decision means for deciding, based on the conflict information, whether an invitation to a participate in a communication session sent from the other client and directed to the client should be forwarded to the client, and to signal the result of the decision to a server.
